(19) United States
(12) Patent Application Publication
(10) Pub. No.: US 2024/0283271 A1
(43) Pub. Date: Aug. 22, 2024

(54) CHARGING CONTROL CIRCUIT

(71) Applicant: ASUSTeK COMPUTER INC., Taipei City (TW)

(72) Inventor: You-Li Wang, Taipei City (TW)

(73) Assignee: ASUSTeK COMPUTER INC., Taipei City (TW)

(21) Appl. No.: 18/501,048

(22) Filed: Nov. 3, 2023

(30) Foreign Application Priority Data
Feb. 20, 2023 (TW) 112106075

(51) Int. Cl. H02J 7/00; H01M 10/46

(52) U.S. Cl. CPC H02J 7/0069; H01M 10/46; H02J 7/0047; H02J 7/0063; H02J 7/007182

(57) ABSTRACT

A charging control circuit is provided. The charging control circuit includes a battery module, an oscillator, a charge pump, and a first switch circuit. The battery module is configured to provide a power supply voltage in a shipping mode. The oscillator is configured to generate an oscillation signal according to the power supply voltage. The charge pump is configured to receive the power supply voltage and boost the power supply voltage in response to the oscillation signal, thereby providing an output voltage to a positive terminal of the battery module. The first switch circuit is coupled between the battery module, the oscillator, and the charge pump and configured to be turned on according to a first switch signal to provide the power supply voltage to the oscillator and the charge pump.

### CROSS-REFERENCE TO RELATED APPLICATION

This application claims the priority benefit of Taiwan application serial no. 112106075, filed on Feb. 20, 2023. The entirety of the above-mentioned patent application is hereby incorporated by reference herein and made a part of this specification.

### BACKGROUND OF THE INVENTION

### Field of the Invention

The invention relates to a charging control circuit for readily releasing the shipping mode of a battery module.

### Description of Related Art

During the process of an electronic device being shipped from the factory to the user's first power-on, the battery module may be over-discharged due to reasons such as long-term leakage current. After receiving the machine, the user is caught in the dilemma that the battery module is out of power and may not be turned on immediately. In order to avoid the above situation, a function that may completely power off the battery module and the system before the machine is shipped is designed. This function is called the shipping mode. To put it simply, one switch (such as a field effect transistor (MOSFET)) is disposed inside the battery module, and the switch is disconnected before the factory ships to cut off the current path between the battery module and the system, so that the battery module does not have any unnecessary power consumption before the user turns it on for the first time. At the same time, the battery gauge IC in the battery module also enters the shutdown mode synchronously, so as to achieve the effect of power saving.

However, when the current system is turned on for the first time, it is necessary to insert a power adapter (such as an AC adapter) into the electronic device to release the shipping mode and return to the normal power supply mode. If the user only intuitively presses the switch button without plugging in the power adapter when turning on the device for the first time, the shipping mode may not be released smoothly. As a result, it is necessary to read the operation manual or call the customer service end for confirmation, thus readily giving users a bad impression of use.

### SUMMARY OF THE INVENTION

The present application provides a charging control circuit. The charging control circuit includes a battery module, an oscillator, a charge pump, and a first switch circuit. The battery module is configured to provide a power supply voltage in a shipping mode. The oscillator is configured to generate an oscillation signal according to the power supply voltage. The charge pump is coupled to the oscillator and configured to receive the power supply voltage and boost the power supply voltage in response to the oscillation signal, thereby providing an output voltage to a positive terminal of the battery module. The first switch circuit is coupled between the battery module, the oscillator, and the charge pump and configured to be turned on according to a first switch signal to provide the power supply voltage to the oscillator and the charge pump.

Based on the above, the charging control circuit of the present application may release the shipping mode of the battery module by only pressing the power button without inserting the power adapter. In this way, the user may more intuitively and readily start the system smoothly, thus achieving a better user experience.

In order to make the aforementioned features and advantages of the disclosure more comprehensible, embodiments accompanied with figures are described in detail below.

### BRIEF DESCRIPTION OF THE DRAWINGS

FIG. 1 is a schematic block diagram of a charging control circuit shown according to an embodiment of the invention.

FIG. 2 is a schematic flowchart of charging control shown according to an embodiment of the invention.

FIG. 3 is a schematic block diagram of a charging control circuit shown according to an embodiment of the invention.

### DESCRIPTION OF THE EMBODIMENTS

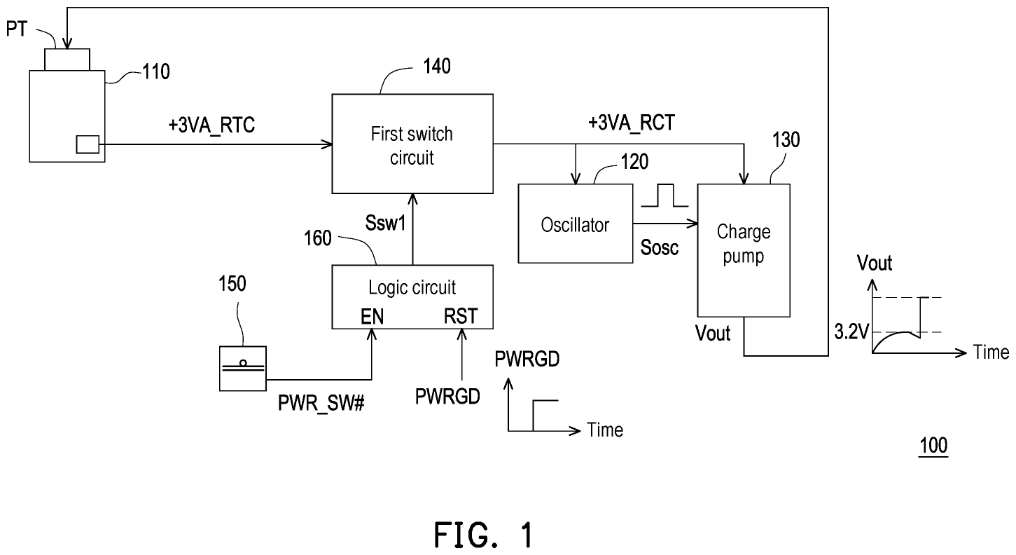

Referring to FIG. 1, a charging control circuit 100 of the present embodiment may be built into an electronic device such as notebook computer, a tablet computer, a personal computer, a smart phone, or a smart TV, for example. The charging control circuit 100 includes a battery module 110, an oscillator 120, a charge pump 130, a first switch circuit 140, a power button 150, and a logic circuit 160.

The battery module 110 may be built-in or external and, for example, includes a battery pack and a control circuit. The battery pack is formed by, for example, one or a plurality of battery cells. The control circuit includes, for example, a battery gauge IC that may calculate the stored power and the charging and discharging current of the battery module 110. In the present embodiment, the battery module 110 may be configured to provide a power supply voltage of +3VA_RTC when set to shipping mode. The power supply voltage +3VA_RTC is originally a set of power supply voltages provided to the central processing unit (CPU) for real time clock (RTC), such as used to remind that the anti-virus software is expired after booting. It should be mentioned that, the power supply voltage +3VA_RTC is not output from a positive terminal PT of the battery module 110, but converted via other paths inside the battery module 110 for output. Therefore, even in the shipping mode in which the current path between the positive terminal PT of the battery module 110 and the system is cut off, the battery module 110 may still provide the power supply voltage +3VA_RTC.

In FIG. 1, the oscillator 120 is coupled to the charge pump 130, and the charge pump 130 is coupled to the positive terminal PT of the battery module 110. The first switch circuit 140 is coupled between the battery module 110, the oscillator 120, and the charge pump 130, and may receive a power supply voltage +3VA_RTC from the battery module 110. The first switch circuit 140 is controlled by a first switch signal Ssw1 output by the logic circuit 160, and may be configured to be turned on according to the first switch signal Ssw1. Accordingly, the power supply voltage +3VA_RTC is provided to the oscillator 120 and the charge pump 130.

In the present embodiment, the user may change the logic level of the first switch signal Ssw1 by pressing the power button 150 to turn on the first switch circuit 140, and then cancel the shipping mode of the battery module 110. The method of releasing the shipping mode of the present embodiment is described in detail below.

In FIG. 1, a first input end (EN end) of the logic circuit 160 is coupled to the power button 150, and an output end of the logic circuit 160 is coupled to the first switch circuit 140. First, when the logic circuit 160 detects that the power button 150 is pressed, for example, via a PWR_SW #signal, the first switch signal Ssw1 of a first logic level may be output from the output end to turn on the first switch circuit 140. Thereby, the power supply voltage +3VA_RTC may be provided to the oscillator 120 and the charge pump 130 via the first switch circuit 140.

The oscillator 120 may be configured to start operating according to the power supply voltage +3VA_RTC to generate an oscillation signal Sosc.

The charge pump 130 may be configured to receive the power supply voltage +3VA_RTC and boost the power supply voltage +3VA_RTC in response to the oscillation signal Sosc, thereby providing an output voltage Vout to the positive terminal

PT of the battery module 110. Specifically, when the oscillator 120 starts to operate to generate the oscillation signal Sosc, the charge pump 130 may continuously boost the power supply voltage +3VA_RTC to exceed 3.2 volts (for example, boost to 5.4 volts) in response to the oscillation signal Sosc, and the boosted voltage is provided to the positive terminal PT of the battery module 110 as the output voltage Vout.

When the output voltage Vout exceeds a first threshold value for a specified time (for example, 100 milliseconds), the battery module 110 may release the shipping mode and return to the normal power supply mode to power the system normally. For example, as shown in FIG. 1, after the output voltage Vout exceeds 3.2 volts for a specified time, the battery module 110 completely releases the shipping mode and supplies power normally, and at the same time the output voltage Vout of the charge pump 130 is pulled up to maintain a steady state. In practical application, the first threshold value may be set as 3.2 volts, for example, but those skilled in the art may make appropriate adjustments according to their actual needs.

Via the above operations, even if the power adapter is not plugged in, the shipping mode of the battery module 110 may be released by pressing the power button 150, thereby achieving a more convenient user experience.

In addition, FIG. 1 shows that the circuit architecture of the charging control circuit 100 is not complicated. That is to say, the charging control circuit 100 of the present embodiment may be formed by only adding a small number of electronic elements to achieve the effect of cost saving.

Moreover, when the second input end (RET end) of the logic circuit 160 receives a reset signal PWRGD, the logic circuit 160 may output the first switch signal Ssw1 of a second logic level from the output end to turn off the first switch circuit 140.

The reset signal PWRGD is, for example, a signal generated during a system boot sequence. For example, as shown in FIG. 1, after the system is ready, the reset signal

PWRGD is pulled up to a high logic level (logic 1). In this way, the first switch circuit 140 is turned off and no longer provides the power supply voltage +3VA_RTC to the oscillator 120 and the charge pump 130, so as to reduce power consumption.

It should be mentioned that, the first logic level may be logic 1 or logic 0, and the second logic level may be logic 0 or 1 complementary to the first logic level, and there is no fixed limitation.

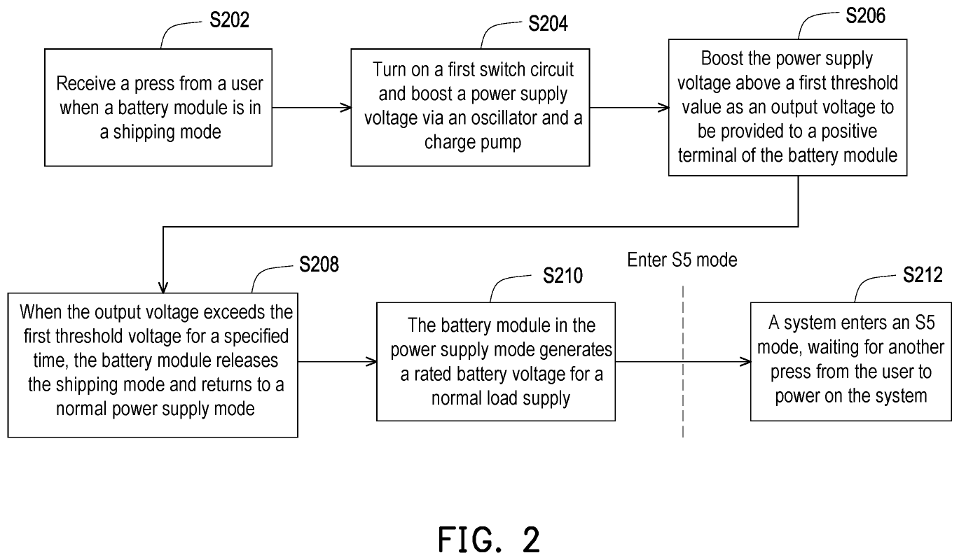

The flow diagram of FIG. 2 is applicable to the charging control circuit 100 of FIG. 1. Please refer to FIG. 1 and FIG. 2 at the same time. The steps in the flow are described below with embodiments.

In step S202, when the battery module 110 is in the shipping mode, the power button 150 receives a press from the user.

Next, in step S204, the first switch circuit 140 is turned on, and the power supply voltage +3VA_RTC is boosted via the oscillator 120 and the charge pump 130.

Next, in step S206, the power supply voltage +3VA_RTC is boosted to exceed the first threshold value, and is provided to the positive terminal PT of the battery module 110 as the output voltage Vout.

Next, in step S208, when the output voltage Vout exceeds the first threshold value for a specified time (for example, 100 milliseconds), the battery module 110 may release the shipping mode and return to the normal power supply mode.

Next, in step S210, the battery module 110 in the power supply mode generates a rated battery voltage Vbat for normal load supply.

Lastly, in step S212, the system enters an S5 mode specified by the Advanced Configuration and Power Interface (ACPI). At this time, the power button 150 waits to be pressed again by the user to start the system.

Regarding step S212, in another embodiment, the system may also be directly powered on after entering the S5 mode via the control of an embedded controller (EC) in the electronic device without waiting for another press.

In an embodiment, in the process of releasing the shipping mode, when the output voltage of the charge pump is boosted to about 2.7 volts, a load connected to the positive terminal of the battery module (such as other chips on the circuit board) may start to operate due to the battery voltage on the positive terminal and cause an additional pumping situation. As a result, the output voltage of the charge pump may not continue to be boosted to 3.2 volts or above, and the condition for releasing the shipping mode may not be satisfied. Therefore, a set of circuits may be designed to forcibly block the current path between the battery module and the load via the switch when the charge pump has not released the shipping mode of the battery module, and the switch may be turned on only after the shipping mode is completely released.

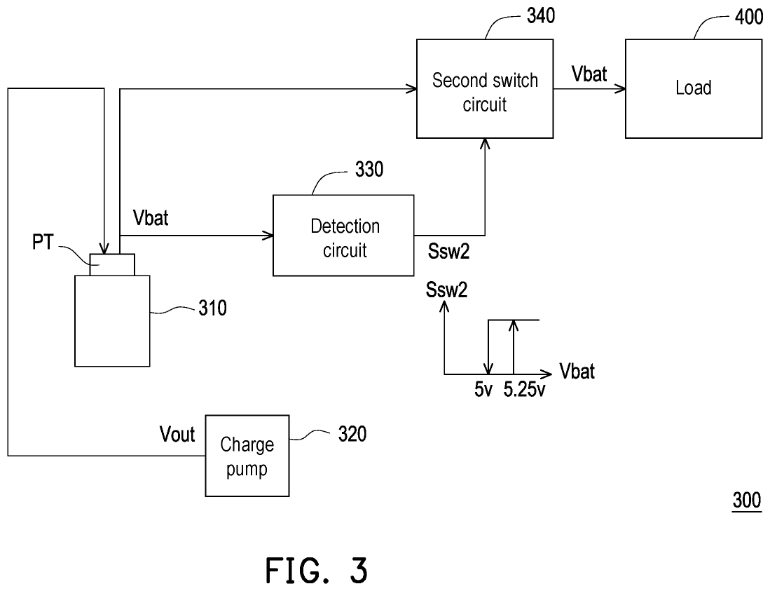

In detail, please refer to FIG. 3, a charging control circuit 300 of the present embodiment includes a battery module 310, a charge pump 320, a detection circuit 330, and a second switch circuit 340. The charge pump 320, the detection circuit 330, and the second switch circuit 340 are all coupled to the positive terminal PT of the battery module 310. The second switch circuit 340 is also coupled to the detection circuit 330. In particular, the battery module 310 and the charge pump 320 of the present embodiment correspond to the battery module 110 and the charge pump 130 of the above embodiments, respectively. Although not explicitly shown, the charging control circuit 300 also includes members corresponding to the oscillator 120, the first switch circuit 140, the power button 150, and the logic circuit 160 of the above embodiments, and the operation mode and function thereof are also the same as those of the above embodiments, so the details thereof are not repeated herein.

The detection circuit 330 may be configured to generate a second switch signal Sw2 according to the battery voltage Vbat on the positive terminal PT. The second switch circuit 340 may be configured to be turned on according to the second switch signal Sw2 to provide the battery voltage Vbat to a load 400.

The second switch circuit 340 may be designed to have a hysteresis function, thereby avoiding too frequent switching between on and off. Specifically, when the second switch circuit 340 is turned off, when the battery voltage Vbat is greater than the second threshold value, the detection circuit 330 may output the second switch signal Ssw2 of the first logic level to turn on the second switch circuit 340. When the second switch circuit 340 is turned on, when the battery voltage Vbat is less than the third threshold voltage, the detection circuit 330 may output the second switch signal Ssw2 of the second logic level to turn off the second switch circuit 340. In the present embodiment, the second threshold value is greater than the third threshold value, and the third threshold value is greater than the first threshold value in the above embodiments.

In practical applications, as shown in FIG. 3, the second threshold value may be set to 5.25 volts, and the third threshold voltage may be set to 5 volts, but those skilled in the art may make appropriate adjustments according to their actual needs.

The battery voltage Vbat on the positive terminal PT is the same as the output voltage Vout of the charge pump 320 before the shipping mode is released, so the battery voltage Vbat is not greater than the second threshold value before the shipping mode of the battery module 310 is completely released. In this way, the second switch circuit 340 is not turned on before the shipping mode of the battery module 310 is completely released, and there is no extra load, so that the shipping mode of the battery module 310 may be successfully released.

Based on the above, the charging control circuit of the invention only needs to add a small number of electronic elements to release the shipping mode of the battery module by only pressing the power button without inserting the power adapter. In this way, the user may more intuitively and readily start the system smoothly, achieving a better user experience.

What is claimed is:

1. A charging control circuit, comprising:
a battery module configured to provide a power supply voltage in a shipping mode;
an oscillator configured to generate an oscillation signal according to the power supply voltage;
a charge pump configured to receive the power supply voltage and boost the power supply voltage in response to the oscillation signal, thereby providing an output voltage to a positive terminal of the battery module; and
a first switch circuit coupled between the battery module, the oscillator, and the charge pump and configured to be turned on according to a first switch signal to provide the power supply voltage to the oscillator and the charge pump.

2. The charging control circuit of claim 1, wherein when the output voltage exceeds a first threshold value for a specified time, the battery module releases the shipping mode.

3. The charging control circuit of claim 1, further comprising:
a power button; and
a logic circuit, wherein a first input end thereof is coupled to the power button, an output end thereof is coupled to the first switch circuit, and when the power button is detected to be pressed, the logic circuit outputs the first switch signal of a first logic level to turn on the first switch circuit.

4. The charging control circuit of claim 3, wherein when a second input end of the logic circuit receives a reset signal, the logic circuit outputs the first switch signal of a second logic level to turn off the first switch circuit.

5. The charging control circuit of claim 1, further comprising:
a detection circuit coupled to the positive terminal of the battery module and configured to generate a second switch signal according to a battery voltage on the positive terminal; and
a second switch circuit coupled to the positive terminal of the battery module and the detection circuit and configured to be turned on according to the second switch signal to provide the battery voltage to a load.

6. The charging control circuit of claim 5, wherein when the second switch circuit is turned off, when the battery voltage is greater than a second threshold value, the detection circuit outputs the second switch signal of a first logic level to turn on the second switch circuit,
when the second switch circuit is turned on, when the battery voltage is less than a third threshold value, the detection circuit outputs the second switch signal of a second logic level to turn off the second switch circuit, wherein the second threshold value is greater than the third threshold value.
